(19) United States
(12) Patent Application Publication
(10) Pub. No.: US 2007/0085502 A1
(43) Pub. Date: Apr. 19, 2007

(54) Braking system and method

(75) Inventor: Aaron L. Graves, Wichita, KS (US)

Correspondence Address: CARGILL, INCORPORATED, LAW/24, 15407 MCGINTY ROAD WEST, WAYZATA, MN, 55391, US

(73) Assignee: CARGILL, INCORPORATED, WAYZATA, MN (US)

(21) Appl. No.: 11/581,189

(22) Filed: Oct. 12, 2006

Related U.S. Application Data
(60) Provisional application No. 60/726,287, filed on Oct. 13, 2005.

(51) Int. Cl. H02P 3/00; G08B 23/00; G08B 21/00; H02B 1/24

(52) U.S. Cl. 318/364; 340/686.6; 340/573.1; 307/116

(57) ABSTRACT

The present invention provides a system and method for stopping equipment. The system is an automatic dynamic braking system using color recognition. The automatic braking system comprises a color recognition sensor coupled to a control system. In use, the control system is operably connected to potentially hazardous equipment. The color recognition sensor recognizes a marker worn by an operator, for example, an article of clothing of a predetermined color. When the marker enters a predetermined recognition zone relative to the equipment, the system responds to the event with shut-down procedures. The equipment may be an electric or automatic saw, with the recognition zone being defined relative to a rotating saw blade.

### CROSS-REFERENCE TO RELATED APPLICATIONS

The present application claims the benefit of U.S. Provisional Application No. 601726,287 filed Oct. 13, 2005 titled BRAKING SYSTEM AND METHOD, incorporated herein by reference.

### BACKGROUND OF THE INVENTION

The present invention provides a braking system and method. More specifically, the present invention provides a system for use with potentially hazardous equipment. More specifically, the present invention provides a dynamic braking system and method using color recognition.

Equipment requiring the presence of an operator in relatively close proximity to moving parts, such as saw blades, have not been equipped with protective devices for rapidly shutting down the equipment when the operator's hands or arms reach a critically dangerous distance from the moving parts. When the “stop” of such equipment is activated, its motor coasts to a stop, which may take from ten seconds, to more than two minutes. Band saws with a 16″ blade will typically coast from 10 seconds, and 36″ saws will take more than two minutes after the “stop” is activated.

### SUMMARY OF THE INVENTION

Accordingly, the present invention provides a system and method for stopping equipment. The system is an automatic dynamic braking system using color recognition. The automatic braking system comprises a color recognition sensor coupled to a control system. In use, the control system is operably connected to potentially hazardous equipment or a potentially hazardous device. The color recognition sensor recognizes a marker, e.g. an article of clothing of a predetermined safety color, worn by an operator. When the marker enters a defined hazardous zone relative to the equipment or device, the automatic braking system responds to the event with stop/shut-down procedures. The equipment may be potentially hazardous equipment such as a saw, a drill, or welding equipment. In one embodiment, the potentially hazardous equipment may be an electric or automatic saw, with the hazardous zone being defined by a distance relative to a saw blade. In one embodiment, the saw may have a rotating blade or an oscillating blade. In one embodiment, the present invention provides an actual stop, emergency stop or complete stop in less than 0.50 second.

### BRIEF DESCRIPTION OF THE DRAWINGS

FIG. 1 shows a schematic view of an automatic braking system in accordance with an embodiment of the present invention;

FIG. 1A shows a schematic view of an automatic braking system in accordance with an embodiment of the present invention;

FIG. 1B shows a schematic view of an automatic braking system in accordance with an embodiment of the present invention;

FIG. 1C shows a schematic view of an automatic braking system in accordance with an embodiment of the present invention;

FIG. 2 shows an enlarged view of the control system of an automatic braking system in accordance with an embodiment of the present invention as in FIG. 1;

FIG. 3 shows an enlarged view as in FIG. 2 showing operation of the automatic braking system;

FIG. 3A shows a flow chart diagram of the operation of the automatic braking system,

FIG. 4 shows a circuit diagram of the automatic braking system in accordance with the present invention; and

FIG. 5 shows an enlarged view of a marker entering a recognition zone in accordance with an embodiment of the present invention.

### DETAILED DESCRIPTION OF THE PREFERRED EMBODIMENTS

The present invention provides system for stopping a device in response to an event, the system comprising detection means for detecting an event, and control means for controlling the device, said control means being in communication detection means. The control means is operably coupled to the device, such that a shut-down procedure is initiated by the control means in response to actuation of the detection means by an event, whereby the device is stopped.

In one embodiment, the present invention provides a braking apparatus comprising a sensor programmed to recognize an object entering a defined or predetermined zone in an area in which a potentially hazardous device operates; and a control system coupled to the sensor, the control system being operably coupled to the saw, such that a braking or shut-down procedure is initiated by the control system in response to actuation of the sensor by an event. In one embodiment, the potentially hazardous device may be a saw, a drill, or welding equipment. In one embodiment, the potentially hazardous device may comprise equipment having a limited-area radiological, biological or chemical hazard.

In one embodiment, the sensor is a color recognition sensor programmed to recognize a marker such as an object of a predetermined color within the defined zone, and a braking procedure is initiated by the control system in response to actuation of the color recognition sensor. The color recognition sensor may be situated so that its “field of view” defines the predetermined zone, and the color recognition sensor determines when the object enters the predetermined zone. The color recognition sensor may be an image processor. In another embodiment the color recognition sensor is any device capable of identifying and determining the location of the object.

The object to be recognized by the sensor may be an article of clothing of a designated safety color. In one embodiment the object is a green safety glove. The glove may be made of any suitable material. In one embodiment, the glove is made of SPECTRA, a man made material, around which green nylon material is woven. This material has been found to resist color degradation, and is virtually shrinkage free.

In an alternative embodiment of the present invention, any suitable marker may be employed. Nonlimiting examples of alternative markers include sensors, magnets, or the like.

In one embodiment of the present invention, the sensor is a radio frequency transceiver, and the marker is a Radio Frequency Identification tag (RFID). Radio Frequency IDentification is a method of storing and remotely retrieving data using devices called RFID tags or transponders. An RFID tag contains an antenna to receive and respond to radio-frequency queries from an RFID transceiver. Passive tags require no internal power source, whereas active tags require a power source.

The device may be equipment having a limited-area radiological, biological or chemical hazard. The device may be equipment such as a saw, a drill or welding equipment. The braking or shut-down procedure may comprise shutting off the device. The procedure may also include actuation of a visible or audible alarm, notification of medical emergency personnel or a supervisor, or prevention of physical access to the hazardous area.

In one embodiment, the hazardous device is a saw, and the procedure includes dynamic braking which stops the saw in about 0.5 seconds or less.

In one aspect, the present invention is directed to a safety method comprising the steps of detecting an object of a designated color within a braking zone in an area in which a hazardous device operates; and automatically initiating a safety procedure with respect to the equipment upon detecting the object.

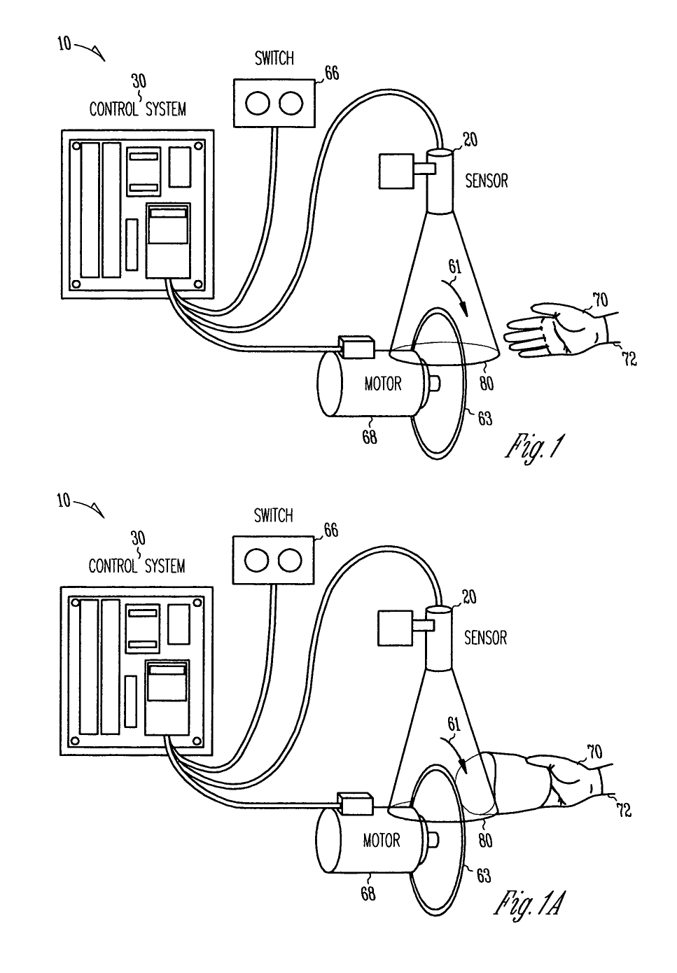

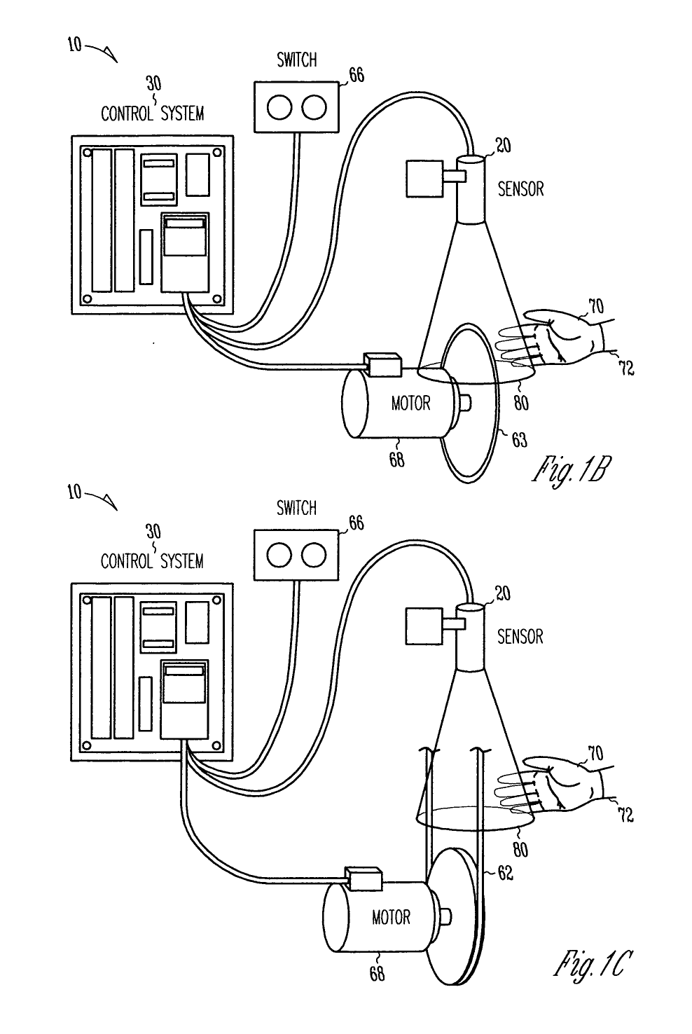

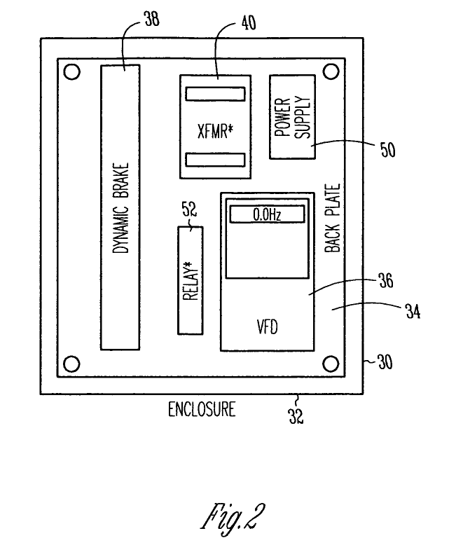

Referring to the Figures, the present invention provides a system and method for braking potentially hazardous equipment. Referring to FIGS. 1-5, an automatic braking system using color recognition is described. The automatic braking system, shown generally at 10 in FIGS. 1, 1A-C, 2 and 3, comprises a color recognition sensor 20 coupled to a control system 30. In use, the control system 30 is operably connected to potentially hazardous equipment. Nonlimiting examples of the potentially hazardous equipment are saws, drills and welding equipment, or equipment having a limited-area radiological, biological or chemical hazard.

In one embodiment of the present invention, the potentially hazardous equipment is a saw. Nonlimiting examples of saws are shown at 60 in FIG. 5, at 63 in FIGS. 1, 1A, 1B, and at 62 in FIG. 1C. The color recognition sensor 20 recognizes a marker. In one embodiment of the present invention, the marker is an article of clothing of a predetermined safety color 70 worn by an operator 72. The control system 20 is electrically coupled to the START-STOP switch 66 and motor 68 of the saw. When the marker, e.g., article of clothing 70, enters a defined zone 80 relative to the equipment, the system responds to the event with braking or shut-down procedures.

The saw 60 may be an electric or automatic saw, with the predetermined recognition zone 80 being defined relative to a saw blade. In one embodiment, the blade is a rotating or oscillating saw blade. In one embodiment, equipment 60 is a band saw 62. In one embodiment, the band saw blade is a continuous loop blade around two vertical wheels rotating in the same direction, and the blade does not oscillate. Referring to FIG. 5, an enlarged view of a predetermined zone of recognition 80 in which a saw operates is shown, with a marker comprising an article of clothing 70 entering the predetermined zone of recognition 80.

In one embodiment, the present invention involves the use of a sensor, shown as a color recognition sensor 20 that is programmed such that it can recognize a high visibility green glove 70 and act upon it. The sensor 20 may comprise a simple camera. In one embodiment, the sensor 20 is a machine vision camera. In one embodiment of the present invention, the camera is a Legend XE camera commercially available from DVT Machine Vision. A color sensor produced by DVT Machine Vision, such as the DVT Machine Vision Legend XE Series Smart Cameras 552C or 554C may be used as sensor 20. Other sensors that may be used include DVT Machine Vision Legend XE Series Smart Cameras 550, 554, and LS. These sensors are of particular utility in washdown applications and other harsh environments. The machine vision system has a stainless steel housing, an IP68 rating, an easy clean case design, built in Ethemet, power and digital I/O connectors, and vision software. Further details of the Legend XE Series Cameras are set forth in product information document SEL-509-A1, Copyright DVT Corporation 2004, incorporated by reference herein in its entirety. Further, additional suitable color sensors are set forth in the 2006 product catalog of Cognex Corporation, available from Cognex Corporation, One Vision Drive, Natick, MA 01760-2059 or its Internet address http://www.cognex.com, incorporated herein by reference in its entirety.

In one embodiment of the present invention, the sensor 20 communicates with the control system 30. Referring to FIG. 2, control system 30 comprises a NEMA 4X SS enclosure 32, a back plate 34, a variable frequency drive (VFD) 36, a dynamic brake resistor 38, a 480V-110V transformer 40, a power supply 50 and a relay 52. One skilled in the art will recognize any combination of a variety of manufactures of these components could be used.

The power supply 50 and the relay 52 are required for the sensing device 20. The sensor 20 communicates with the variable frequency drive 32, alerting it to the presence of the green article 70 then invokes the VFD 32 to stop. In turn, the motor 68 comes to a rapid stop. When this process is applied to potentially hazardous equipment such as a saw, for example a band saw or a meat saw, the sensor 20 detects the presence of the glove 70, stops the saw, and prevents injuries.

In one embodiment, the present invention provides an actual stop in less than 0.50 second. The present invention provides motor braking with a variable frequency drive (VFD), dynamic brake resistor and DC injection. A DC injection unit is an electronic device that provides smooth, frictionless braking of AC motors. It does not use brake discs or shoes so it does not wear out or need maintenance.

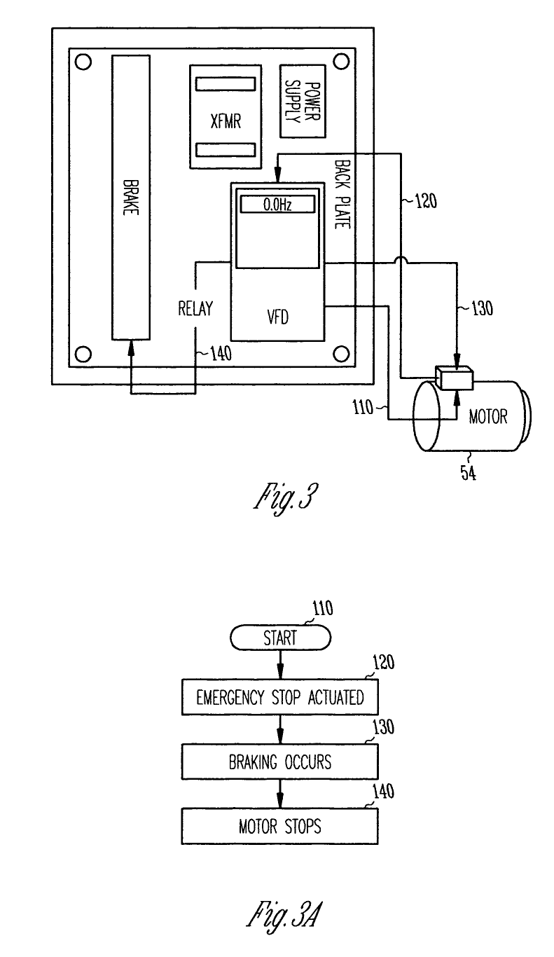

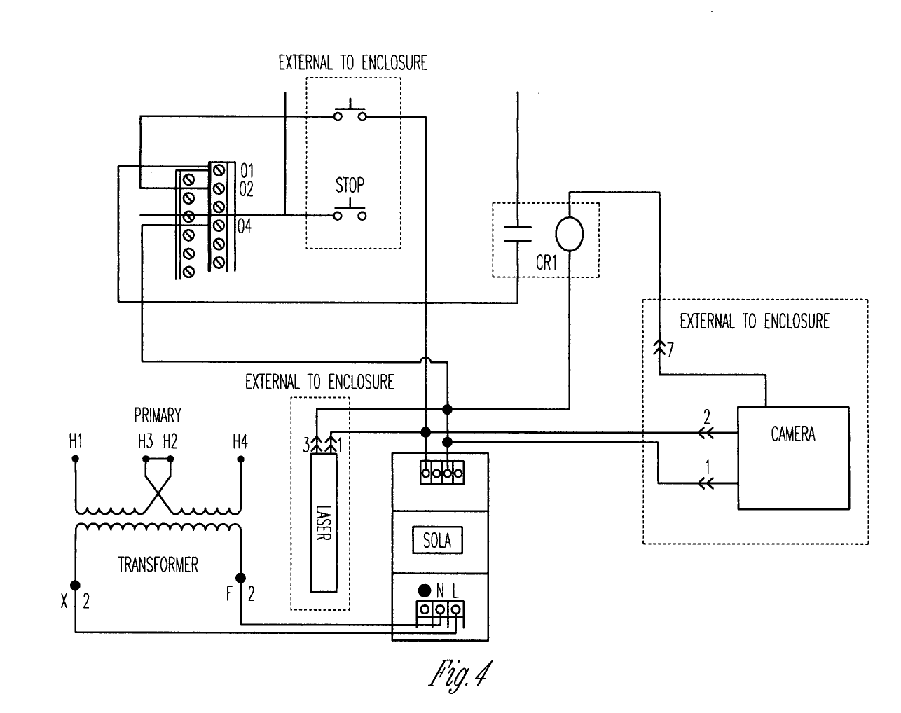

Referring to FIG. 3, a schematic diagram of the operation of the braking system is shown. FIG. 3A shows a flow chart diagram of the operation of the braking system. FIG. 3 shows a process of dynamic motor braking with a sensing device. In operation, at (110) the system starts. The drive ramps to 60 HZ, supplying voltage to the motor. At (120), the emergency stop is actuated. in response to actuation of the emergency stop, voltage is applied to the VFD, and the VFD quickly ramps to 0.0 HZ and transfers the motor voltage back to the VFD buss. At (130), braking occurs. The VFD injects DC voltage for 1 second, and the DC injection creates a stationary 0.0 HZ magnetic field in place of the rotating 60 Hz field to brake the motor. At (140), the motor stops within about 0.50 second. The VFD transfers the buss voltage to the dynamic brake resistor, resulting in the motor stopping within about 0.50 second.

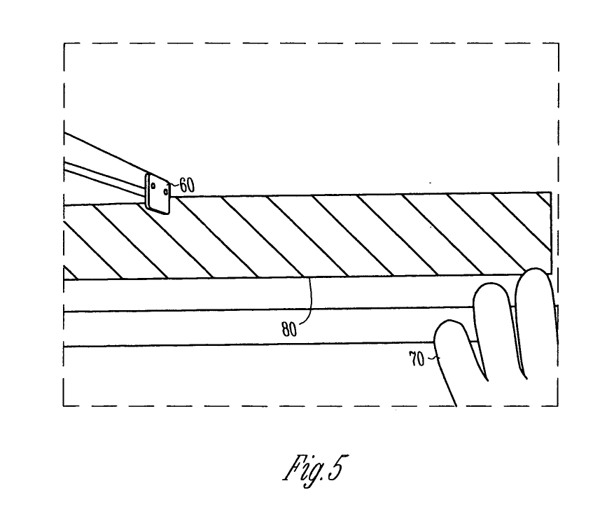

An electrical circuit diagram of the braking system in accordance with the present invention is provided at FIG. 4.

The dynamic motor braking with sensing devices as shown, may be used in conjunction with any appropriate sensing devices, such as the following nonlimiting examples—infrared temperature sensors, proximity switches, or color recognition sensors. The safety system employing such a feature may be used with a variety of hazardous equipment. In particular, injuries to the hand from use of a saw could be eliminated by detecting the presence of a hand or metal glove, and then stopping the saw.

The color recognition sensor determines whether a marker having a specific color enters the hazardous zone. In one embodiment, the article of clothing is a bright green glove. Other markers which may be worn by an operator such as a ring, wrist band, finger cot, or the like may be utilized in accordance with the present invention. In alternative embodiments, in response to the marker entering the defined zone, the control system may automatically turn off the equipment, actuate an audible or visual alarm, notify medical or emergency personnel or a manager, or actuate a safety shield to physically prevent access to the hazardous area.

The system for use with a meat saw would be subjected to a daily cleaning such as a wash down with a 180 degree caustic solution at 20-180 PSI from a distance of 4-6 feet. Such a system would include protective devices for the color recognition sensor, including but not limited to a lens cover for the machine vision camera, a protective cover for the communications cable, or the like. The lens cover may be replaced as often as once every six months. In addition, an “o” ring may be integrated into the cover or camera.

The camera is trained by software included with the commercially available camera. In one embodiment, the camera is a machine vision camera.

In one embodiment, the present invention provides an actual stop or emergency stop in less than 0.50 second. The present invention provides motor braking with a variable frequency drive (VFD), dynamic brake resistor and DC injection. A DC injection unit is an electronic device that provides smooth, frictionless braking of AC motors. It does not use brake discs or shoes so it does not wear out or need maintenance.

In operation, the ramp drives to 60 HZ, applying voltage to the motor. In response to actuation of the emergency stop, voltage is applied to the VFD. The VFD quickly ramps to 0.0 HZ and transfers the motor voltage back to the VFD buss. The VFD injects DC voltage. The DC injection creates a stationary 0.0 HZ magnetic field in place of the rotating 60 Hz field to brake the motor. The VFD transfers the buss voltage to the dynamic brake resistor. The motor stops within 0.50 second.

On embodiment of the invention provides dynamic motor braking with sensing devices. Dynamic motor braking used in conjunction with sensing devices such as infrared temperature sensors, proximity switches, or color recognition sensors, eliminates the vast majority of injuries from potentially hazardous devices or equipment. In one embodiment, the sensing device detects the presence of a hand or metal glove, and then stops the motor so the potentially hazardous device or equipment (saw) is stopped.

The color recognition sensor determines whether an article of clothing having a specific color enters the hazardous zone. In one embodiment, the article of clothing is a bright green glove. The color recognition sensor may be situated so that its “field of view” defines the hazardous area. In one embodiment, the color recognition sensor may be an image processor. In another embodiment the color recognition sensor is any device capable of identifying and determining the location of the article of clothing.

In alternative embodiments, in response to the article of clothing entering the defined hazardous zone, the control system may automatically turn off the equipment, actuate an audible or visual alarm, notify medical or emergency personnel or a manager, or actuate a safety shield to physically prevent access to the hazardous area.

While the invention has been described in detail herein in accordance with certain preferred embodiments thereof, many modifications and changes therein may be effected by those skilled in the art without materially departing from the novel teachings and advantages of this invention. Accordingly, all such modifications are intended to be included within the scope of this invention as defined in the following claims and, therefore, it is our intent to be limited only by the scope of the appending claims and not by way of the details and instrumentalities describing the embodiments shown herein.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention which is to be given the full breadth of any and all equivalents thereof.

What is claimed is:

1. A braking system comprising:
a sensor configured to provide a signal representative of an object entering a predetermined zone of recognition in an area in which a device operates; and
a control system coupled to the sensor, the control system being operably coupled to the device, such that a shut-down procedure is initiated by the control system in response to actuation of the sensor by an event.

2. The braking system according to claim 1 wherein control system further comprises a housing, a back plate, a variable frequency drive (VFD) having a buss, a dynamic brake resistor, a transformer, a power supply and a relay.

3. The braking system according to claim 1 wherein the sensor comprises a color recognition sensor programmed to recognize an object of a predetermined color within the recognition zone, and a shut-down procedure is initiated by the control system in response to actuation of the color recognition sensor.

4. The braking system according to claim 3 wherein the color recognition sensor has a field of view which defines the recognition zone, and the color recognition sensor determines when the object enters the recognition zone.

5. The braking system according to claim 4 wherein the object is an article of clothing of a designated color.

6. The braking system according to claim 5 wherein the object is a green glove.

7. The braking system according to claim 1 wherein the device is a saw.

8. The braking system according to claim 7 wherein the shut-down procedure includes dynamic braking which stops the saw in about 0.5 seconds or less.

9. The braking system according to claim 1 wherein the shutdown procedure includes actuation of a visible or audible alarm.

10. The braking system according to claim 1 wherein the shut-down procedure includes notification of personnel.

11. The braking system according to claim 1 wherein the shut-down procedure includes prevention of physical access to the area in which the device operates or prevention of physical access to the zone of recognition.

12. The braking system according to claim 1 wherein the device is selected from the group consisting of saws, drills, and welding equipment.

13. The braking system according to claim 1 wherein the device comprises equipment having a limited-area radiological, biological or chemical hazard.

14. A method of stopping a device comprising:
detecting an object of a designated color within a predetermined recognition zone in an area in which a device operates; and
automatically initiating a shut-down procedure with respect to the device upon detecting the object.

15. The method according to claim 14 wherein the shut-down procedure includes actuation of a visible or audible alarm.

16. The method according to claim 14 wherein the shut-down procedure includes notification of personnel.

17. The method according to claim 14 wherein the shutdown procedure includes prevention of physical access to the area in which the device operates or the zone of recognition.

18. The method as in claim 14 wherein the step of detecting includes providing a braking apparatus comprising a sensor programmed to recognize the object entering the zone of recognition, and a control system coupled to the sensor, the control system being operably coupled to the device, such that the shut-down procedure is automatically initiated by the control system in response to actuation of the sensor by detection of the object.

19. The method as in claim 18 wherein the object is an article of clothing of a predetermined color, and the sensor is a color recognition sensor programmed to recognize an object of a predetermined color within the zone of recognition, and wherein the shut-down procedure is initiated by a control system in response to actuation of the color recognition sensor by detection of the object entering the zone of recognition.

20. The method according to claim 19 wherein the shut-down procedure includes dynamic braking which stops the device in about 0.5 seconds or less.

21. The method according to claim 19 wherein the control system further comprises a housing, a back plate, a variable frequency drive (VFD) having a buss, a dynamic brake resistor, a transformer, a power supply and a relay, and dynamic braking includes the steps of:
(a) the VFD ramping to 60.0 HZ, supplying voltage to the motor;
(b) the VFD quickly ramping to 0.0 HZ and transferring the motor voltage back to the VFD buss;
(c) the VFD injecting DC voltage for 1 second to brake the motor; and
(d) the VFD transferring the buss voltage to the dynamic brake resistor, whereby the motor is stopped in about 0.50 second or less.

22. The method according to claim 19 wherein the object is a green glove.

23. The method according to claim 14 wherein the device is a selected from the group consisting of saws, drills and welding equipment.

24. The method according to claim 23 wherein the device is a saw.

25. The method according to claim 14 wherein the device comprises equipment having a limited-area radiological, biological or chemical hazard.

26. A system for stopping a device in response to an event, the system comprising:
detection means for detecting an event; and
control means for controlling the device, said control means in communication with the detection means, the control means being operably coupled to the device, such that a shut-down procedure is initiated by the control means in response to actuation of the detection means by an event., whereby the device is stopped.
